(19) United States
(12) Patent Application Publication
(10) Pub. No.: US 2003/0057361 A1
(43) Pub. Date: Mar. 27, 2003

(54) Tilt switch

(76) Inventor: Tien-Ming Chou, Taichung City (TW)

Correspondence Address: BROOKS & KUSHMAN, 1000 TOWN CENTER 22ND FL, SOUTHFIELD, MI, 48075

(21) Appl. No.: 09/957,932

(22) Filed: Sep. 21, 2001

(51) Int. Cl. G01J 1/36; G06M 7/00

(52) U.S. Cl. 250/221; 250/227.22

(57) ABSTRACT

A tilt switch includes an optoelectronic sensor member with light emitting and receiving units disposed in an insulating housing. A ball member is received rollably in an accommodating chamber of the housing. When the housing is tilted, the ball member can move between a first position, where a light beam emitting from the emitting unit is permitted to be received by the receiving unit so as to enable the receiving unit to make an electrical connection between two terminals, and a second position, where the light beam is prevented from being received by the receiving unit so as to break the electrical connection.

### BACKGROUND OF THE INVENTION

1. Field of the Invention

This invention relates to a tilt switch, more particularly to a tilt switch with an optoelectronic sensor member which is controlled by the displacement of a ball member to make or break electrical connection between two electric contact terminals.

2. Description of the Related Art

Referring to FIG. 1, a conventional tilt switch 1 is shown to include an insulating housing 101 with an accommodating chamber 102 formed therein for receiving an electric conductive ball member 103. A pair of electric contact terminals 105 have upper ends which are received in the accommodating chamber 102 through two holes 104 formed in the housing 101, and lower ends which are disposed outwardly and downwardly of the housing 101. An insulating upper member 106 is secured on an upper edge of the housing 101 to close an opening 107 of the housing 101. Thus, when the housing 101 is in an upright state shown in FIG. 1, the ball member 103 contacts the terminals 105 to establish electrical connection between the terminals 105. Once the housing 101 is tilted, the ball member 103 is moved to disengage the terminals 105, thereby breaking the electrical connection. However, when the tilt switch 1 is used in a moist place, the ball member 103 is liable to oxidize, thereby resulting in unstable electrical connection of the terminals 105.

### SUMMARY OF THE INVENTION

The object of the present invention is to provide a tilt switch which can provide a stable electrical connection between two electric contact terminals.

According to this invention, the tilt switch includes an insulating housing, an optoelectronic sensor member, and a ball member. The housing is adapted to be mounted on a support in an upright direction, and includes an inner housing wall which confines an accommodating chamber therein. The optoelectronic sensor member is secured to the housing, and includes light emitting and receiving units which are disposed opposite to each other in a transverse direction relative to the upright direction and which respectively define a light emitting path and a light receiving path that extend through the inner housing wall and into the accommodating chamber, and two electric contact terminals which are respectively and electrically connected to the light emitting and receiving units and which extend downwardly and outwardly of the housing so as to be adapted to be connected electrically to the support. The ball member is received in the accommodating chamber, and is rollable between first and second positions when the housing is tilted relative to the upright direction. The ball member is disposed such that a light beam emitting from the light emitting unit along the light emitting path enters the light receiving path by virtue of the displacement of the ball member to the first position so as to be received by the light receiving unit and enable the receiving unit to make an electrical connection between the electric contact terminals, and such that the light beam emitting from the light emitting unit along the light emitting path is prevented from entering the light receiving path by virtue of the displacement of the ball member to the second position so as to break the electrical connection between the electric contact terminals.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional schematic view of a conventional tilt switch in an upright state;

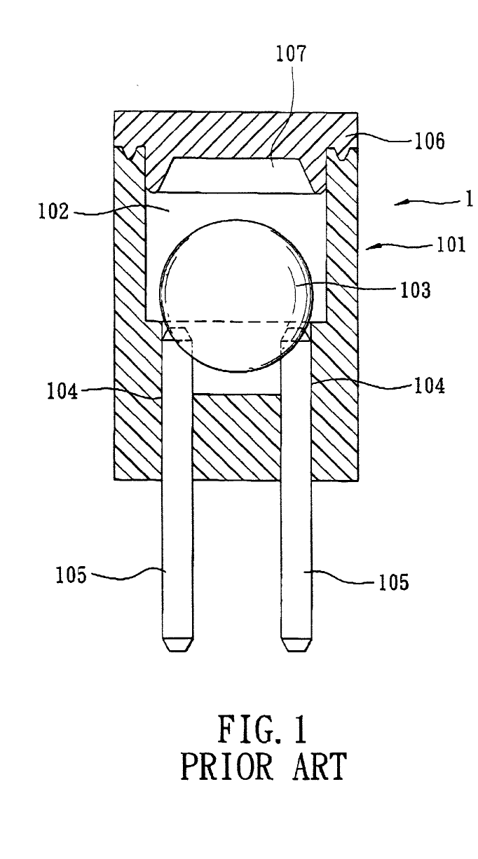

FIG. 2 is an exploded perspective view of a first preferred embodiment of a tilt switch according to this invention;

FIG. 3 is a sectional schematic view of the first preferred embodiment in an upright state;

FIGS. 4 and 5 are sectional schematic views of the first preferred embodiment when tilted;

FIG. 6 is a fragmentary perspective view of a second preferred embodiment of the tilt switch according to this invention;

FIG. 7 is a sectional schematic view of the second preferred embodiment in an upright state;

FIG. 8 is a top schematic view of the second preferred embodiment in the upright state, an upper member thereof being removed for the sake of clarity;

FIGS. 9 and 10 are top schematic views similar to FIG. 8, but with a housing of the tilt switch in a tilted state;

FIG. 11 is an exploded, partly fragmentary perspective view of a third preferred embodiment of the tilt switch according to this invention;

FIG. 12 is a top schematic view of the third preferred embodiment in the upright state, an upper member thereof being removed for the sake of clarity;

FIG. 13 is a sectional schematic view of the third preferred embodiment in the upright state; and

FIGS. 14 and 15 are sectional schematic views of the third preferred embodiment when tilted.

### DETAILED DESCRIPTION OF THE PREFERRED EMBODIMENTS

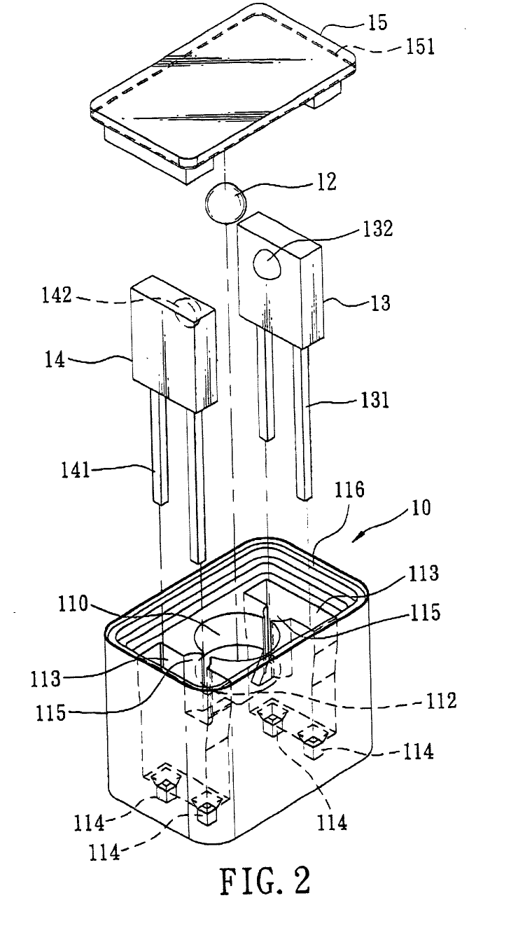

Referring to FIG. 2, the preferred embodiment of the tilt switch according to the present invention is adapted to be in electric contact with a support (not shown), and is shown to comprise an insulating housing 10, an optoelectronic sensor member, and a ball member 12.

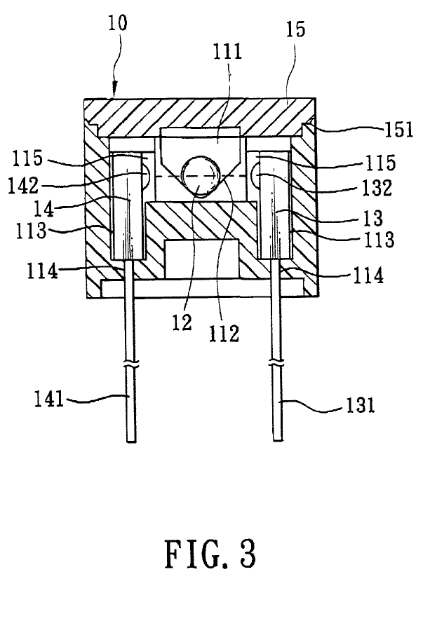

With reference to FIG. 3, the insulating housing 10 is adapted to be mounted on the support in an upright direction, and is made of a plastic material. The housing 10 includes an inner housing wall 110 which confines an accommodating chamber 111 therein, and two concavities 113 which are disposed opposite to each other in a transverse direction relative to the upright direction, and two pairs of through holes 114 which extend from the concavities 113 through a bottom portion of the housing 10. An insulating upper member 15 is secured on an upper portion of the housing 10 by ultrasonic welding of a peripheral portion 151 to a periphery 116 of the upper portion of the housing 10 so as to enclose sealingly the accommodating chamber 111 and the concavities 113. The inner housing wall 110 has a pair of emitting and receiving slits 115 which are formed opposite to each other in the transverse direction and which extend and which are aligned with each other in the transverse direction to respectively communicate with the concavities 113. In addition, the inner housing wall 110 is formed with a rolling surface 112 which includes a central area and a surrounding area surrounding the central area. In this embodiment, the rolling surface 112 is inclined radially and downwardly from the surrounding area to the central area.

The optoelectronic sensor member includes a known infrared light emitter 13 and a known optoelectronic switch 14. The infrared light emitter 13 is retained in the concavity 113, and has an emitting point 132 which is disposed in the emitting slit 115 and which faces the accommodating chamber 111 to define a light emitting path, and a pair of electric contact terminals 131 which extend downward through the through holes 114 and outwardly of the bottom portion of the housing 10 so as to connect electrically with an electrical power unit (not shown) of the support. The optoelectronic switch 14 is retained in the other concavity 113, and has a receiving point 42 which is disposed in the receiving slit 115 and which faces and which is aligned with the emitting point 132 along a line parallel to the transverse direction so as to define a light receiving path that extends along the line. A pair of electric contact terminals 141 extend downward through the through holes 114 and outwardly of the bottom portion of the housing 10 so as to connect electrically with the support.

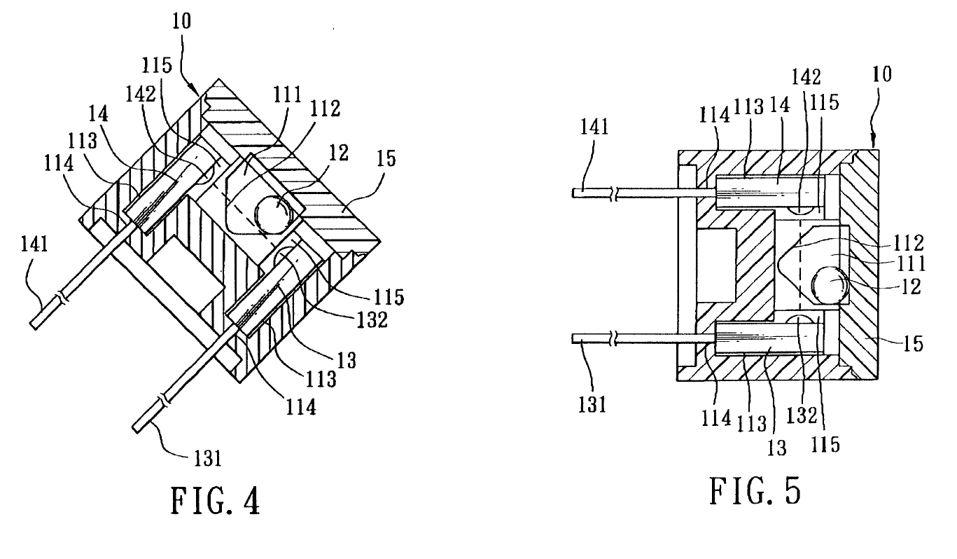

The ball member 12 is made of copper alloy, iron alloy or gilding material, and is received rollably in the accommodating chamber 111. As such, when the housing 10 stands in the upright direction, as shown in FIG. 3, the ball member 12 is displaced to the central area of the rolling surface 112 so as to stand in the line of the light emitting and receiving paths, thereby preventing entrance of the light beam emitting from the emitting point 132 into the receiving slit 115 and breaking an electrical connection between the electric contact terminals 141. As shown in FIGS. 4 and 5, once the housing 10 is tilted, the ball member 12 will roll to the surrounding area by virtue of gravity to stand out of the line. Thus, the light beam emitting from the light emitting point 132 can enter the receiving slit 115 so as to be received by the receiving point 142, thereby enabling the optoelectronic switch 14 to make the electrical connection between the electric contact terminals 141.

By means of the arrangements of the optoelectronic sensor member 13,14 and the ball member 12, the tilt switch of this invention can provide a more stable electrical connection between the electrical contact terminals 141 as compared to that of the prior art which uses an electrically conductive ball member to achieve direct electrical contact with two electric contact terminals.

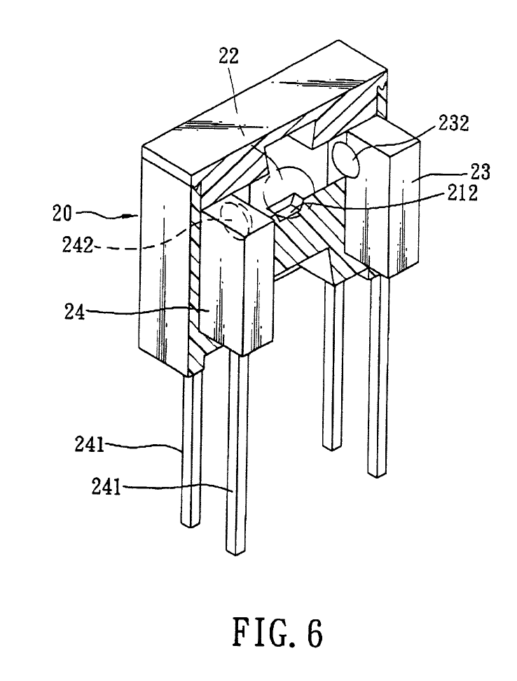

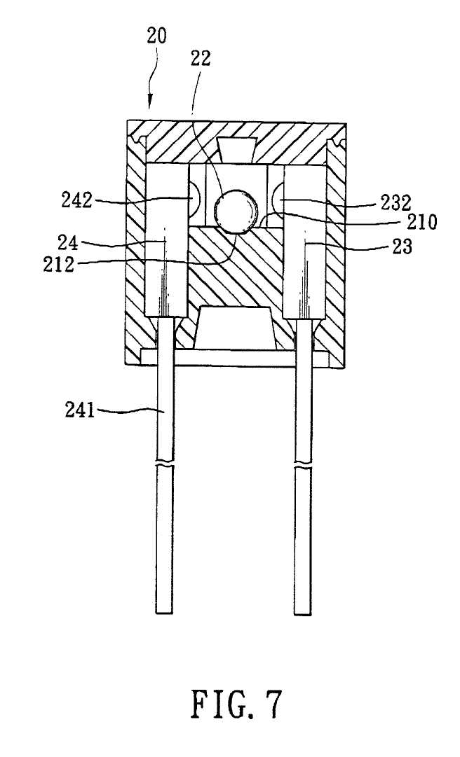

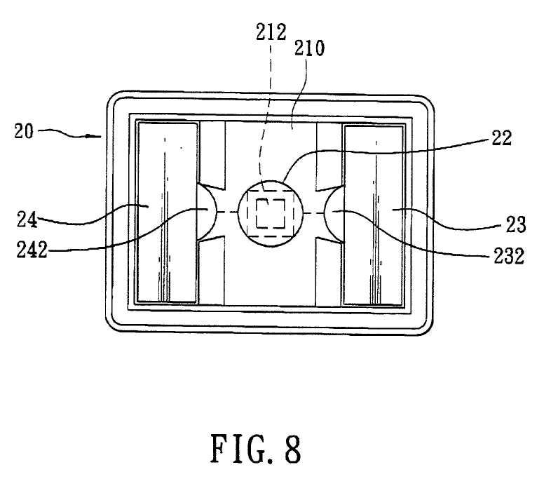

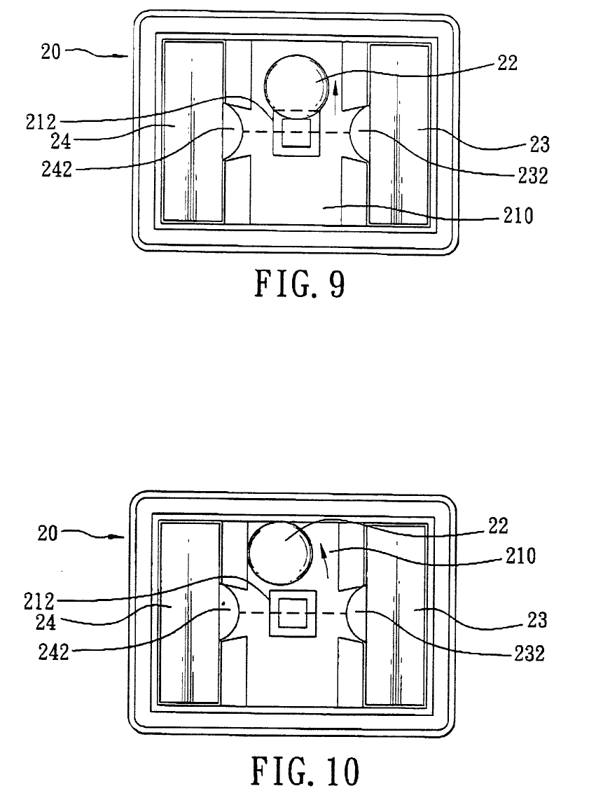

Referring to FIGS. 6, 7 and 8, the second preferred embodiment of the tilt switch of this invention is shown to have a construction similar to that of the first preferred embodiment. However, in this embodiment, the rolling surface 210 of the insulating housing 20 extends in a horizontal plane, and is formed with a concaved portion 212 on the central area thereof. As such, when the housing 20 stands in the upright direction, the ball member 22 is displaced to the central area and is retained by the concaved portion 212 to prevent the receiving point 242 of the optoelectronic switch 24 from receiving the light beam emitting from the emitting point 232 of the infrared light emitter 23 so as to break the electrical connection between the electric contact terminals 241. Referring to FIGS. 9 and 10, once the housing 20 is tilted, the ball member 22 will roll from the concaved portion 212 and out of the line of the light emitting and receiving paths such that the light beam emitting from the emitting point 232 can be received by the receiving point 242 for enabling the optoelectronic switch 24 to make the electrical connection between the electric contact terminals 241.

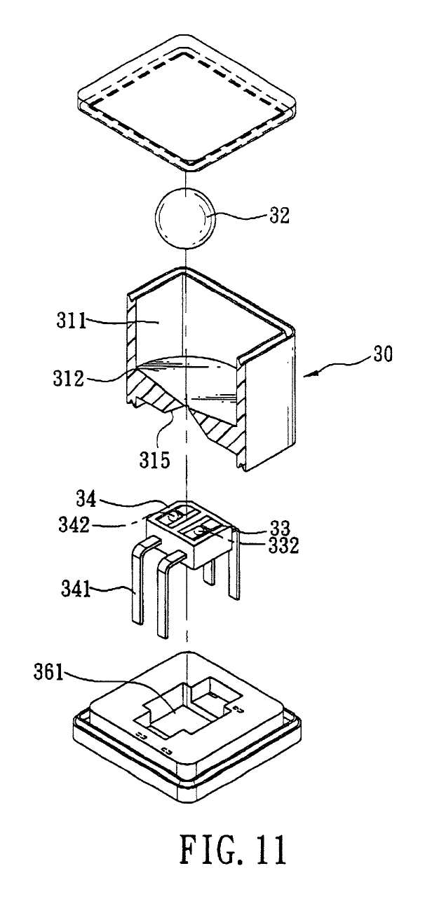

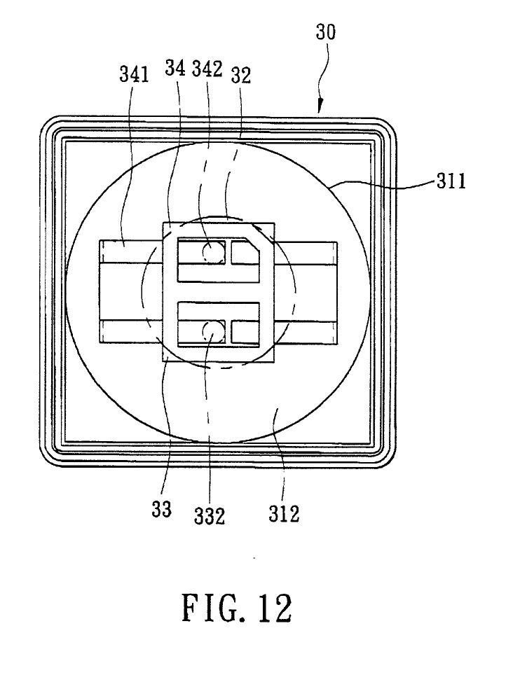

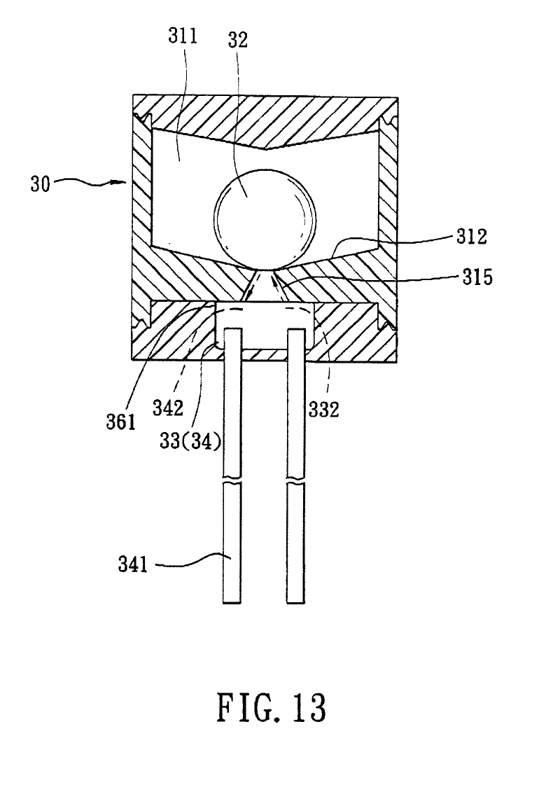

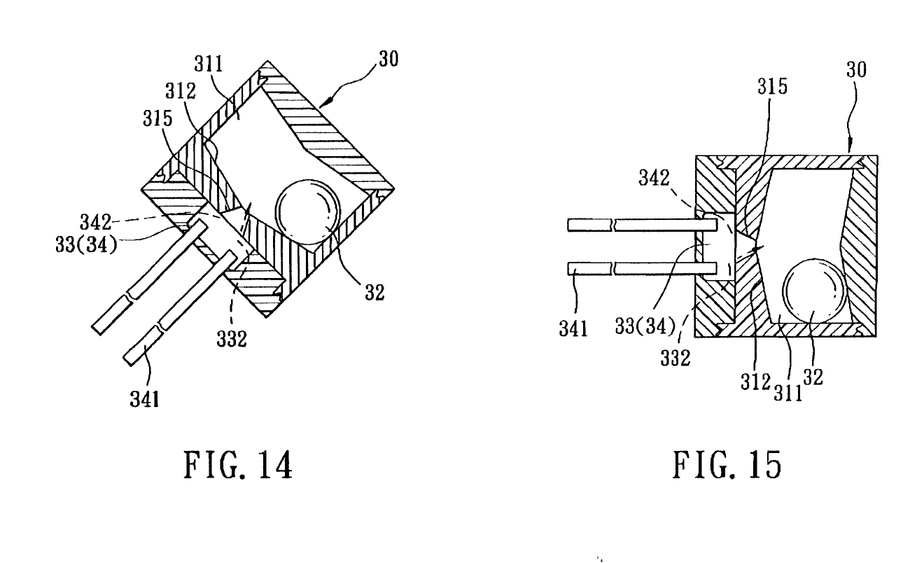

Referring to FIGS. 11, 12 and 13, the third preferred embodiment of the tilt switch of this invention is shown to include an insulating housing 30 with an accommodating chamber 311, and a concavity 361 which is disposed beneath the central area of the rolling surface 312 for receiving an infrared light emitter 33 and an optoelectronic switch 34 of an optoelectronic sensor member such that emitting and receiving points 332,342 of the emitter 33 and the switch 34 face towards the central area of the rolling surface 312. The inner housing wall of the housing 30 has a flared alit 315 which extends in the upright direction to communicate the concavity 361 with the central area. In addition, the rolling surface 312 inclines radially and downwardly from the surrounding area to the central area such that the ball member 32 is displaced to the central area when the housing 30 stands in the upright direction. As shown in FIG. 13, in this state, the light beam emitting from the emitting point 332 can be deflected by the ball member 32 to enter via the slit 315 into the receiving path so as to be received by the receiving point 342, thereby enabling the optoelectronic switch 34 to make the electrical connection between the electric contact terminals 341. As shown in FIGS. 14 and 15, once the housing 30 is tilted, the ball member 32 will roll to the surrounding area of the rolling surface 312, and the light beam emitting from the emitting point 332 will enter the accommodating chamber 311 via the slit 315 and will not be received by the receiving point 342 so as to break the electrical connection between the electric contact terminals 341.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A tilt switch adapted to be in electric contact with a support, said tilt switch comprising:
an insulating housing adapted to be mounted on the support in an upright direction, and including an inner housing wall which confines an accommodating chamber therein;
an optoelectronic sensor member secured to said housing, and including light emitting and receiving units which are disposed opposite to each other in a transverse direction relative to the upright direction and which respectively define a light emitting path and a light receiving path that extend through said inner housing wall and into said accommodating chamber, and two electric contact terminals which are electrically connected to said receiving unit and which extend downwardly and outwardly of said housing so as to be adapted to be connected electrically to the support; and
a ball member received in said accommodating chamber, and rollable between first and second positions when said housing is tilted relative to the upright direction, said ball member being disposed such that a light beam emitting from said light emitting unit along the light emitting path enters the light receiving path by virtue of the displacement of said ball member to the first position so as to be received by said light receiving unit and to enable said light receiving unit to make an electrical connection between said electric contact terminals, and such that the light beam emitting from said light emitting unit along the light emitting path is prevented from entering the light receiving path by virtue of the displacement of said ball member to the second position so as to break the electrical connection between said electric contact terminals.

2. The tilt switch of claim 1, wherein said optoelectronic sensor member includes an infrared light emitter with an emitting point and which serves as said light emitting unit, and an optoelectronic switch with a receiving point and which serves as said light receiving unit.

3. The tilt switch of claim 2, wherein said insulating housing has two concavities disposed opposite to each other in the transverse direction and retaining said infrared light emitter and said optoelectronic switch therein respectively, said inner housing wall having emitting and receiving slits which are spaced apart from each other, which extend and which are aligned with each other along a line parallel to the transverse direction, and which are communicated with said concavities to form said light emitting and light receiving paths, respectively,
said inner housing wall having a rolling surface including a central area to locate said ball member in the second position, where said ball member is disposed in said line, and a surrounding area surrounding said central area to locate said ball member in the first position, where said ball member is disposed out of said line, such that when said housing stands in the upright direction, said ball member is displaced to said central area so as to interrupt entrance of the light beam from said emitting slit into said receiving slit, and such that once said housing is tilted, said ball member is displaced to said surrounding area and is disposed out of said line so as to permit the entrance of the light beam into said receiving slit.

4. The tilt switch of claim 3, wherein said rolling surface is inclined radially and downwardly from said surrounding area to said central area.

5. The tilt switch of claim 3, wherein said central area is formed with a concaved portion.

6. The tilt switch of claim 2, wherein said inner housing wall has a rolling surface which includes a central area to locate said ball member in the first position, and a surrounding area surrounding said central area to locate said ball member in the second position, and which inclines radially and downwardly from said surrounding area to said central area such that said ball member is displaced to the first position when said housing stands in the upright direction,
said housing further having a concavity which is disposed beneath said central area and which retains said infrared light emitter and said optoelectronic switch therein such that said emitting and receiving points face towards said central area, said inner housing wall having a slit which extends in the upright direction to communicate said concavity with said central area, and which together with said emitting and receiving points, respectively form said light emitting and receiving paths such that when said ball member is displaced to said central area, the light beam emitting from said emitting point is deflected by said ball member to enter via said slit into said receiving path so as to be received by said receiving point.
